(19) United States
(12) Patent Application Publication
(10) Pub. No.: US 2015/0199414 A1
(43) Pub. Date: Jul. 16, 2015

(54) Locally cached file system

(71) Applicants: David E. Braginsky, Mountain View, CA (US); Justin M. Rosenstein, Oakland, CA (US); Eric Joseph Uhrhane, Palo Alto, CA (US); David Jeske, San Francisco, CA (US)

(72) Inventors: David E. Braginsky, Mountain View, CA (US); Justin M. Rosenstein, Oakland, CA (US); Eric Joseph Uhrhane, Palo Alto, CA (US); David Jeske, San Francisco, CA (US)

(21) Appl. No.: 11/323,199

(22) Filed: Dec. 30, 2005

(51) Int. Cl. G06F 17/30

(52) U.S. Cl. CPC G06F 17/30578; G06F 17/30132; G06F 17/30864; G06F 17/301

(57) ABSTRACT

A locally cached file system provides disconnected operation and universal access to data stored on a server system over a network. Changes to files made on a client system are synchronized to the server system asynchronously. A client system operating in synchronized mode maintains copies of files stored on the server system, or at least in user-defined folders of a virtual hard drive established on the server system. Asynchronous file upload and/or download operations are made transparent to the user through an automated background process, whereby in some embodiments meta-data for files to be transferred is sent to the server system first, followed by the files. In some embodiments, transfer order is governed by a user-defined priority policy based on one or more parameters, such as when the files were last modified directory location, file size and/or file type.

### RELATED APPLICATION

This application is related to U.S. application Ser. No. ______, Attorney Docket No: 60963-5133, filed Dec. 30, 2005, entitled “Conflict Management During Data Object Synchronization Between Client and Server,” which application is incorporated by reference herein in its entirety.

### TECHNICAL FIELD

The disclosed embodiments relate generally to computer file management and in particular to managing files over a network.

### BACKGROUND

Today, most people's computer files (e.g., documents, photos, songs, movies, etc.) and other items (e.g., calendar events, emails, tasks, etc.) exist on one or more personal physical devices (e.g., laptops, desktops, PDAs, mobile phones, etc.). This hinders the management and production of information in a number of ways. For example, access to files is typically not ubiquitous across multiple physical devices. It is generally difficult for a user to walk into an Internet café or grab a friend's computer and view or edit a draft document that was started on a different computer. File synchronization is also difficult if a user works on the same document on multiple devices. To ensure the most current version of a document is available, a user may have to repeatedly email modified versions of the document to himself, or remember to consistently store a copy of the current version on a portable drive (e.g., a USB drive), which are techniques that are prone to errors. This problem is compounded during collaboration where multiple document versions may have to be managed via email or merged manually. Finally, if hard disks fail or a laptop is stolen, valuable information may be lost if the user lacks the know-how or the discipline to back-up data.

Networked file systems for business enterprises solve some, but not all of these file management problems for corporations and institutions who can afford such systems. Few consumers, however, have the ability or patience to create and maintain a network application for themselves and everyone with whom they wish to collaborate.

### SUMMARY OF EMBODIMENTS

A locally cached file system provides disconnected operation and access to data stored on a server system over a network. Changes to files made on a client system are automatically synchronized to the server system asynchronously. A client system operating in synchronized mode maintains copies of files stored on the server system. These files may be stored in folders of a virtual hard drive established on the server system. Asynchronous file upload and/or download operations are made transparent to the user through an automated background process. In some embodiments meta-data for files to be transferred is sent to the server system first, followed by the files. In some embodiments, file transfer order for a set of files to be transferred is governed by a user-defined priority policy based on one or more parameters, such as date and time of last file modification, folder or directory locations of the files (i.e., the locations of the files in a directory hierarchy), file size, and file type.

A computer-readable medium stores instructions, which, when executed by a processor in a computer system, causes the processor to perform the operations of: accessing a first file system coupled to the processor, wherein the first file system is associated with a second file system located on a computer network; presenting a user interface on a display device for allowing user interaction with the first file system; and automatically synchronizing at least portions of the first file system with the second file system asynchronously.

A method of managing files over a network includes locally accessing a first file system, wherein the first file system is associated with a remotely located second file system; enabling user interaction with the first file system; and automatically synchronizing at least portions of the first file system with the second file system asynchronously.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram of one embodiment of a file management system, including a locally cached file system.

FIG. 2 is a block diagram of one embodiment of a locally cached file system.

FIG. 3 is a block diagram of one embodiment of a meta-directory.

FIG. 4 is a block diagram of one embodiment of a worker module.

FIG. 5 is a flow diagram of one embodiment of a share update process flow.

FIG. 6 is a flow diagram of one embodiment of an on-demand process flow.

FIG. 7 is a flow diagram of one embodiment of a file synchronization process flow.

FIG. 8 is a block diagram of one embodiment of a client device for implementing the locally cached file system shown in FIG. 2.

FIG. 9 is a block diagram of one embodiment of a meta-directory tree to provide a look-up path for meta-entries.

FIG. 10 is a block diagram of a server system in accordance with some embodiments.

Like reference numerals refer to corresponding parts throughout the drawings.

### DESCRIPTION OF EMBODIMENTS

### File Management System

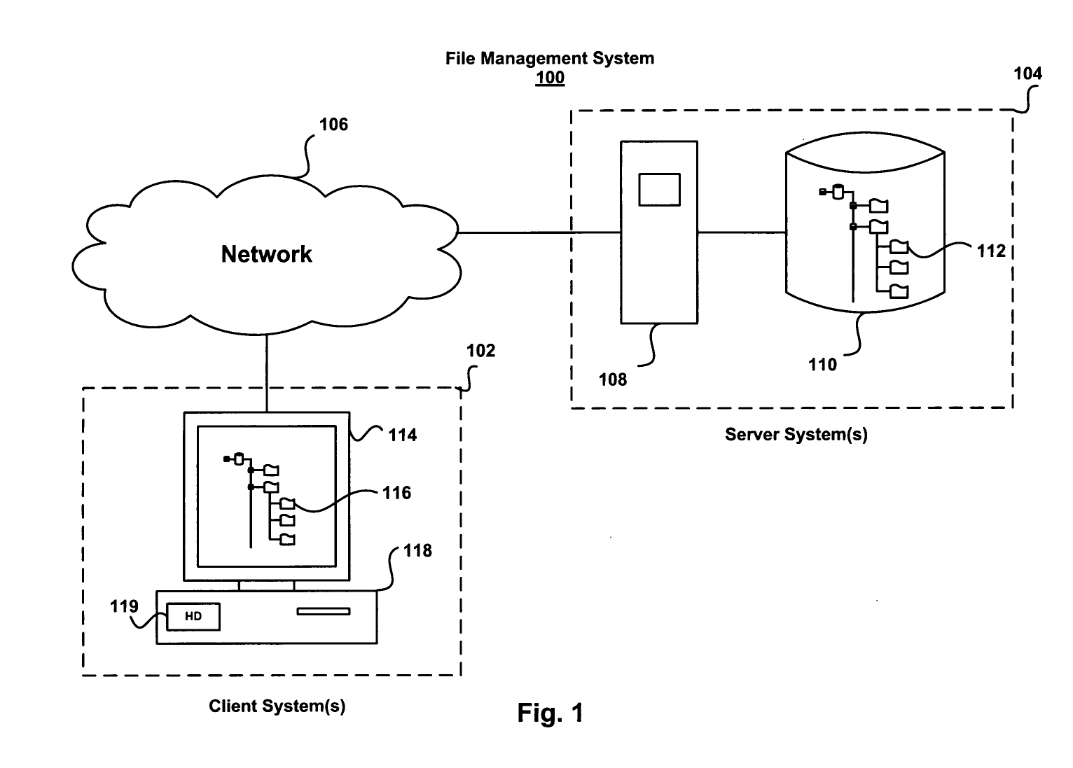

FIG. 1 is a block diagram of one embodiment of a file management system 100 including a one or more client systems 102 (e.g., laptop computer, desktop computer, personal digital assistant (PDA), mobile phone, media player, etc.) coupled to one or more server systems 104 via a network 106. The network 106 can be one or more networks having one or more types of topologies, including but not limited to the Internet, intranets, local area networks (LANs), wireless networks, Ethernet, Storage Area Networks (SANs) and the like. The client system 102 generally includes a processor 118 coupled to a display device 114 for presenting a locally cached file system 116 to the user. In some embodiments, the file system 116 manages files stored in a cache data structure on one or more data storage devices 119 (e.g., random access memory (RAM), hard disk, optical disk, portable storage device, etc.). The term “cache” or “cache data structure” is not limited to cache memory but can include any data structure on the computer-readable medium 119 that is accessible to the client system 102.

The server system 104 (e.g., a file server) generally includes a processor 108 coupled to one or more computer-readable mediums. The computer-readable medium 110 includes a file system 112, herein sometimes called a “remote file system” because it is remotely located relative to the client system 102. In some embodiments, the locally cached file system 116 has a same or similar file structure as the remote file system 112.

The file management system 100 is not limited to the configuration shown in FIG. 1 but can include more or fewer components. For example, the client and server systems 102, 104, would typically include hardware and software components for establishing and maintaining a connection over a network and for communicating and exchanging information with other network devices.

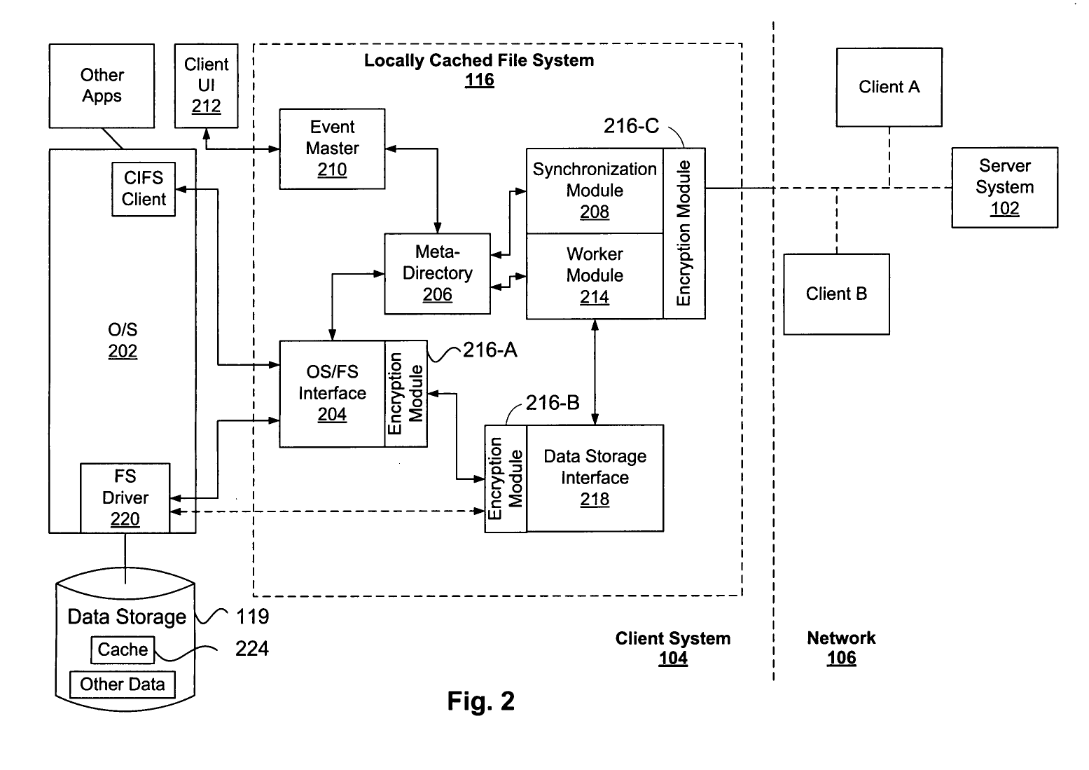

A user can manage files on the client system 102 using the locally cached file system 116. File management includes all the various operations typically associated with files, including but not limited to creating, deleting, opening, editing, moving, copying, renaming, saving, searching and the like. Files can include any known data structures or formats, including but not limited to text files, documents, digital images, video files, web pages, emails, applications, instant messages, audio files, video files, calendar events, music files, or any other data or applications that may reside on one or more computer systems. The file system 116 can have any topology or configuration, including but not limited to the ubiquitous hierarchal directory/folder/file architectures used by WINDOWS, LINUX, MAC OS and UNIX operating systems. The file system 116 is capable of periodically synchronizing with the server system 104 asynchronously to receive updates and other information, as described with respect to FIGS. 2-9.

In some embodiments, the file system 116 is implemented as a “local server” in the client system 102. In such an embodiment, the file system 116 can be part of an application that is installed on the client system 102. In some embodiments, the file system 116 is installed on the client system 102 as a virtual hard drive that is integrated into the native file system to provide all the functionality of a local physical hard drive.

During the installation process the user can be prompted to select a desired drive letter for the virtual hard drive and the maximum amount of physical hard disk space to cache files. A shortcut icon on the user's desktop or a start menu option can be used to launch or activate the file system 116. Alternately, the virtual hard drive may be configured to be automatically treated by applications on the client 102 as an additional local hard drive, without requiring any special action on the part the user. Various dialog boxes can be presented to the user as a guide through the installation process, such as prompting the user to select a password or register with the server system 104.

In some embodiments, when the client system 102 is connected to the server system 104 the virtual drive becomes a file hierarchy containing files and folders that are visible to the user (i.e., for which the user has the appropriate access rights). If the client system 102 is not connected to the server system 104, then the file hierarchy represents the most recent local cache of the file hierarchy, together with whatever modifications have been made to the locally cached file system 116 since the last synchronization with the remote file system 112.

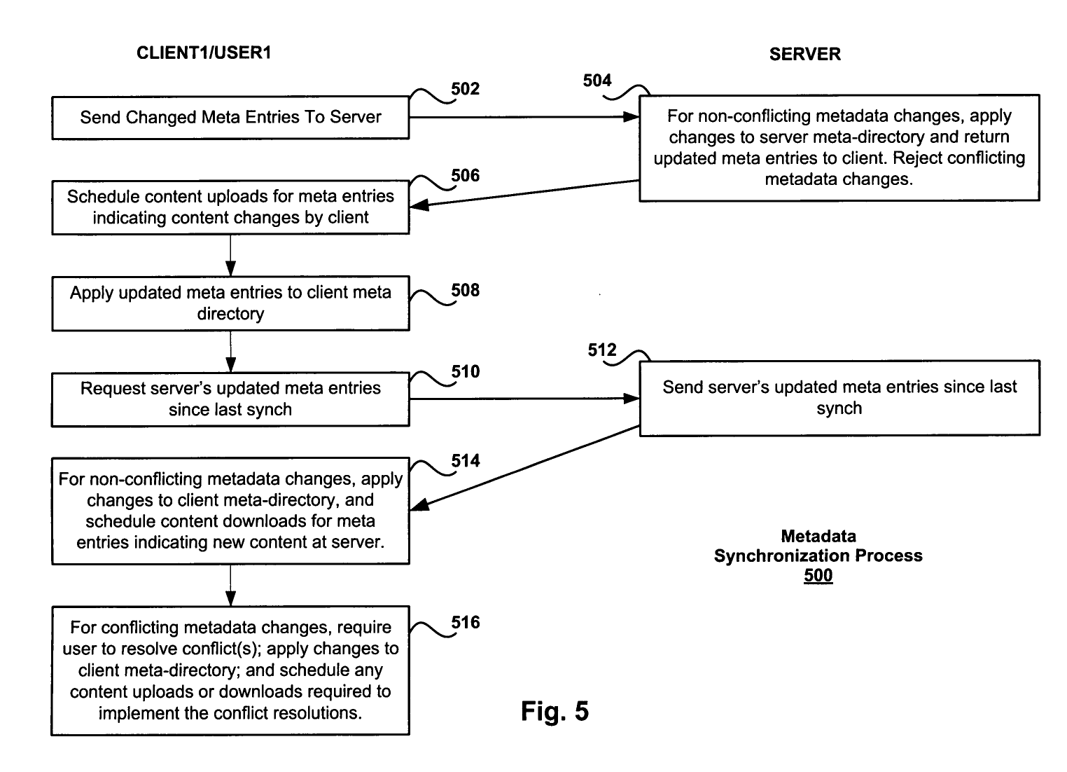

If a user is connected to the server system 104 via the network 106, then the file system 116 returns the most recent version of the requested file, whether cached locally in file system 116 or stored remotely in file system 112. In some embodiments, the selection of the latest version of the requested file can be based on a comparison of file timestamps located in a meta-directory stored on the client system 102, as described below with respect to FIG. 5. In some circumstances, the entire file may have to be downloaded from the server system 104 to the client system 102 to service a request. This may happen, for instance, when the server has a newer version of the file than the client, and the process of downloading the newest version to the client did not begin prior to the request.

If the client system 102 is not connected to the server system 104, then the file system 116 returns the locally cached version of the requested file. If there is no cached version of the file, then the file system 116 returns an error and notifies the user (e.g., through a callout bubble) that the requested file is not available offline.

### Access Control

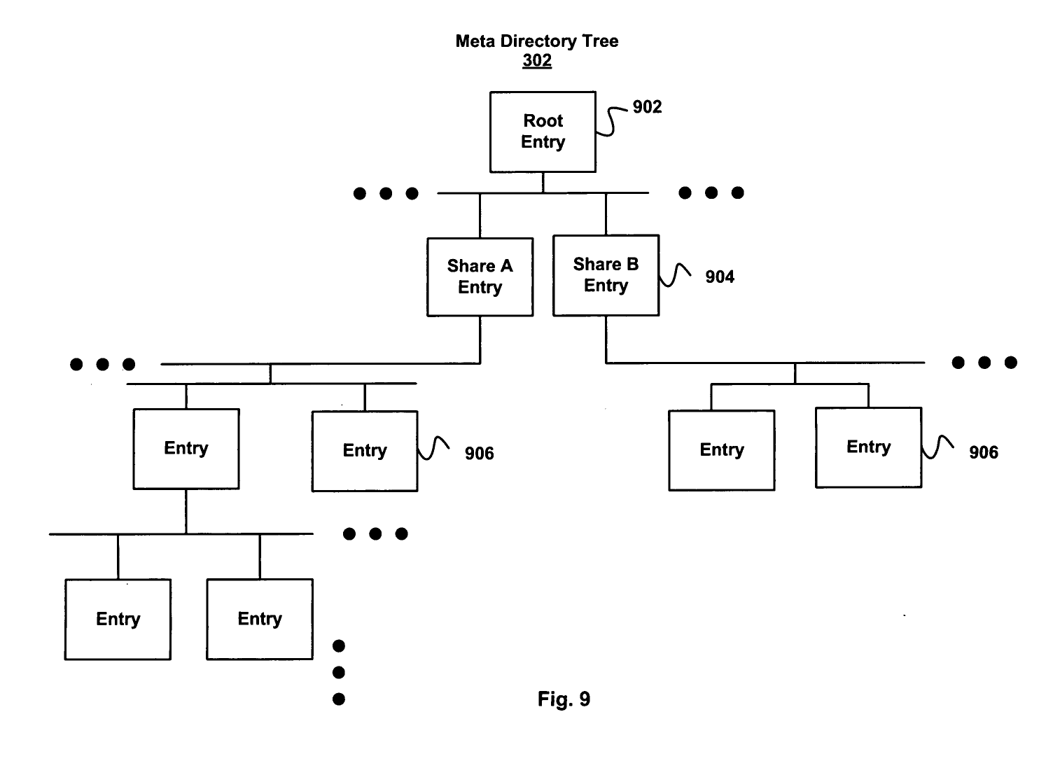

In some embodiments, the actions that a user is allowed to take on files in the file system 116 are determined by an access control model. For example, if a user attempts to create a new folder in the virtual hard drive's root entry (see FIG. 9), an access denied error will be returned by the file system 116 if the user does not have write access for the root entry. Similarly, if a user opens a document for which the user has read access but not write access, the document will be opened in read-only mode. In some embodiments, users or applications can be restricted from directly changing permissions of files through operating system mechanisms (e.g., the chmod command used in Unix and Linux).

In some embodiments, access to files in the file system 116 is governed by the normal file locking mechanisms of the resident operating system. For example, if one application has a text file open for editing, then another application cannot open the same text file for editing. Moreover, if the client system 102 is connected to the server system 104, and an application attempts to open a text file for editing (or attempts to write to a text file) while an edit session is in progress on another client system (as indicated by metadata associated with the file), the file system 116 can refuse to open the text file for editing and notify the requester that the file is in use.

### Locally Cached File System

FIG. 2 is a block diagram of one embodiment of the locally cached file system 116 shown in FIG. 1. The file system 116 includes an operating system/file system (OS/FS) interface 204, a meta-directory 206, a synchronization module (syncer) 208, an event master 210, a client user interface (UI) 212, a worker module 214, optional encryption modules 216 and a data storage interface 218. The meta-directory 206 stores metadata concerning files in the file system 116, including information about the synchronization state of each such file. In some embodiments, the files are stored in a cache 224 in a data storage device 119 that can be accessed through File I/O calls from the resident operating system (O/S) 202 (e.g., Microsoft Windows, Linux, Mac OS, Unix, etc.) and a driver 220 (e.g., a disk driver) to control access to the data storage device 119. Note that applications (e.g., word processor, etc.) can read and write to files in cache 224 via the O/S 202 as if they were reading and writing files in the native file system. Thus, applications do not need to be modified to interact with the file system 116.

### OS/FS Interface

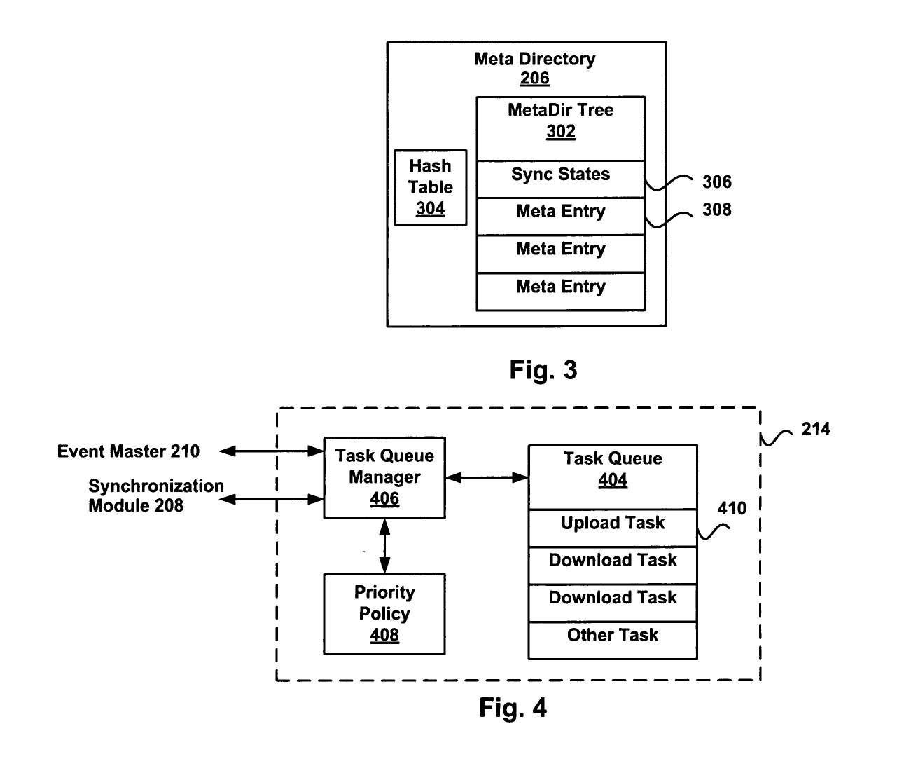

In some embodiments, the file system 116 mounts as part of the native file system and communicates with the resident O/S 202. In such embodiments, the OS/FS interface 204 handles communications between the O/S 202 and the file system 116. In some embodiments, the OS/FS interface 204 is implemented as a Common Internet File System (CIFS) or Server Message Block (SMB), which encapsulates CIFS handling and is initialized with an instance of a meta-directory class, as described with respect to FIG. 3.

CIFS defines a standard remote file-system access protocol for use over the Internet (or other network), enabling groups of users to work together and share documents across the Internet or within corporate intranets. In some embodiments, CIFS includes a CIFS server (not shown) and a CIFS client 230 which are both simultaneously resident on the client system 102. An example of a CIFS server is the JLAN CIFS server developed by STARLASOFT. An example of a CIFS client is the File Sharing Client built into WINDOWS, which can connect to the CIFS server on a standard port. When there are no active network connections (e.g., during a network disconnect), WINDOWS will not allow CIFS connections. In some embodiments, to enable continued access to the locally cached file system even when there are no active network connections, a network loopback adapter (implemented in software) is used, which allows local CIFS connections to continue operation, or to be re-established. The CIFS client 230 communicates directly with the O/S 202 and the CIFS server communicates directly with the file system 116. The CIFS server translates incoming requests from the CIFS client into I/O requests that are similar to Portable Operating System Interface (POSIX) I/O requests, such as create_file( ), create_dir( ), open( ), write( ), read( ), rename( ), move( ), close( ), etc.

At least some I/O calls may result in changes to the meta-directory 206. For example, create_dir( ) inserts a new meta-entry 308 in the meta-directory 206 at the appropriate location, as described below with respect to FIG. 3. The read( ) and write( ) methods use the meta-directory 206 to find an appropriate meta-entry 308 for the file and then read or write to the data file associated with that meta-entry 308. In some embodiments, reading and writing to data files stored in the cache 224 associated with meta-entries 308 can be accomplished using well-known file management interfaces, such as the JAVA FileIO API.

### Meta-Directory

Referring to FIGS. 2 and 3, the meta-directory 206 communicates with the OS/FS interface 204 and the synchronization module 208. In some embodiments, the meta-directory 206 is stored in memory (e.g., RAM) and periodically backed-up to non-volatile storage (e.g., hard disk). In some embodiments, the meta-directory 206 includes a meta-directory tree 302. The tree 302 includes a collection of meta-entries 308. In some embodiments, the meta-directory 206 also includes a hash table 304 that allows quick look-ups of meta-entries 308 using file identifiers (e.g., file IDs) and/or file paths.

Referring to FIGS. 2 and 9, in some embodiments the root entry 902 of the tree 302 represents a virtual drive mounted on the native file system. The child entries 904 immediately below the root entry 902 correspond to shares, each of which has its own share ID. A “share” is a group of files that are accessible by one or more users in accordance with an access control model and can exist independent of the users. The lower levels of entries 906 beneath the share entries 902 are meta-entries 308/906. When a user browses his virtual drive represented by the root entry 902, the OS/FS 204 traverses the branches of tree 302 and returns directory and file information obtained from the meta-directory 206. Thus, the meta-directory tree 302 can be used to quickly look-up meta-entries 308 along a path established by the tree 302.

The meta-directory 206 can be read from data storage 119 (e.g., hard disk) during startup and written to data storage 119 whenever a meta-entry 308 is modified. In some embodiments, each share is stored in a separate SQLite database in data storage 119. The meta-directory 206 also stores synchronization states 306 for each meta-entry 308 modified by the locally cached file system 116 (e.g., in response to a command from an application executed by the client) or updated by the synchronization module 208. The synchronization states 306 contain the current state of synchronization for the meta-entries 308, and can be used to notify the user of upload/download progress via client UI 212.

The meta-entries 308 (hereinafter also referred to as “meta-data” or “entry”) include information that is associated with files. For example, a meta-entry 308 could include one or more of the following fields listed in Table I below:

TABLE I
Example of Meta-Entry Fields

| Field Name | Description |
|---|---|
| GUID | file ID |
| parent_id | ID of parent of file (e.g., folder) |
| child_id | ID of child of file (e.g., a file or folder) |
| Version | The server system version of this file |
| Name | The file name |
| user_size | Size of the data |
| storage_size | Actual size required to store the data (may be |
| | different than user_size for encrypted files) |
| Cs | Checksum of the data |
| Mtime | When the file was last modified |
| ctime | When the file was created |
| mode | OS dependent mode fields |
| attributes | OS dependent attribute fields |
| flags | Status flags (e.g., IS_DIRTY, |
| | IS_ENCRYPTED, etc.) |
| has_data | Whether the file data is locally available |
| has_data_s | If the server system has data for this entry |
| sync_ts | The server timestamp of when this entry was |
| | last changed on the server |

The meta-entries 308 also contain pointers to other entries in the meta-directory 206. In particular, each meta-entry 308 points to its parent and child meta-entries (if any) inside the meta-directory 206, thus forming the meta-directory tree 302 structure shown in FIG. 9.

A request received from the OS/FS interface 204 that modifies a meta-entry 308 will set its IS_DIRTY flag. In some embodiments, setting the IS_DIRTY flag causes the synchronization module 208 to automatically commit the file to the server system 104 for file synchronization. An open file request may sometimes fail, because the requested file is not locally available. If the data is unavailable (e.g., has_data=0) and the server system 104 is reachable, the synchronization module 208 automatically schedules a download of the data while blocking other requests to modify the same data until the data is available. In some embodiments, when a request to access a file fails, a request to download that file is automatically given high priority within a predefined prioritization scheme for ordering file downloads to the client system.

### Client UI

The client UI 212 displays file status information to the user, prompts the user for information and allows the user to issue commands, such as commands for monitoring shares (groups of files to which the user has access rights), changing users or exiting the file system 116. In embodiments using WINDOWS, most interaction with the user can be done using a taskbar icon, sometimes called a quick launch icon or system tray icon. The taskbar icon can use different images to indicate different connectivity and synchronization states. For instance, the taskbar icon can indicate whether there are unresolved conflicts. When the user right-clicks on the icon, the user is presented with a menu from which different commands can be selected. In addition to a taskbar icon, the user can be presented with notification panels to provide messages such as upload/download status and the like.

In some embodiments, the client UI 212 communicates with the file system 116 over a socket and displays status information to the user. For example, in some embodiments, when a file is being downloaded, the client UI 212 presents a progress indicator (e.g., a progress bar) and an estimated time of completion for the file. Whenever the file system 116 needs to get input from the user, it requests the information from the client UI 212, which then prompts the user for the requested information. The client UI 212 can also send user initiated requests to the file system 116, such as mounting a new share or shutting down the file system 116. In some embodiments, the client UI 212 can be used to schedule and manage automatic updating from the server system 104, as described with respect to FIG. 5.

### Event Master

The event master 210 handles communications between the client UI 212 and the other components in file system 116, and in this sense acts as a “switchboard” or “information hub” for the file system 116. In some embodiments, the communications are handled using sockets, which allows the client UI 212 to be a separate application. In some embodiments, the client UI 212 can be written using programming (e.g., object code) native to the hosting platform. The event master 210 exposes an interface to the other components of file system 116 for sending and receiving events. It can be initialized as either a client or a server. The server will listen on a port, while the client will attempt to connect to the server. This allows events to be forwarded across the socket in both directions.

### Synchronization Module (Syncer)

The synchronization module 208 commits “dirty” meta-entries to the server system 104, gets updates from the server system 104, and integrates the updates in the meta-directory 206 at the appropriate meta-entries 308. It also schedules files for upload/download via the worker module 214 and maintains a synchronized clock with the server system 104. If a user is logged in to the file system 116 and the client system 102 is connected to the network 106, then the synchronization module 208 uses available bandwidth to maintain synchronization with the remote file system 112 in server system 104. In some embodiments, the synchronization module 208 automatically polls the server system 104 for the latest meta-data and file information and requests and handles conflict resolution instructions from the user (obtained via the Client UI 212 and the Event Master 210). The handling of conflict resolution is described in co-pending U.S. patent application Ser. No. ______, filed ______, entitled “Conflict Management During Data Object Synchronization Between Client And Server,” Attorney Docket No. 60963-5133.

An important aspect of the synchronization module 208 is its ability to synchronize the meta directory 206 and the files in the file system 116 with the server system 104 asynchronously in a background process using a separate process thread. This capability allows applications (e.g., a word processor, browser, etc.) to continue to run without significant interruption, even while the synchronization module 208 and worker module 214 are exchanging meta-data and/or file data with a file server 104. Stated in another way, meta-data and file synchronization does not block the user from using the client to perform various tasks, such as web browsing, email, other communication tasks, file access and modification tasks, and so on.

In some embodiments, the synchronization module 208 communicates with the server system 104 by making Hypertext Transport Protocol (HTTP) requests to the Uniform Resource Locator (URL) of the server system 104. The URL can be generated by a file system message class and include a request type (e.g., GET, PUT) having one or more arguments, such as user ID, password and protocol version. If the request is of type PUT, then the Content-Length header can be set to the size of the PUT data. In some embodiments, the server system 104 will return a header if the protocol version on the client system 102 does not match the protocol version on the server system 104, or if the user does not have permissions to perform the requested action.

### Work Module

Referring to FIGS. 2 and 4, the worker module 214 includes a task queue 404, a task queue manager 406 and a priority policy 408. The task queue manager 406 communicates with the event master 210 and the synchronization module 208, and is responsible for ordering the tasks in the task queue 404 in accordance with the priority policy 408.

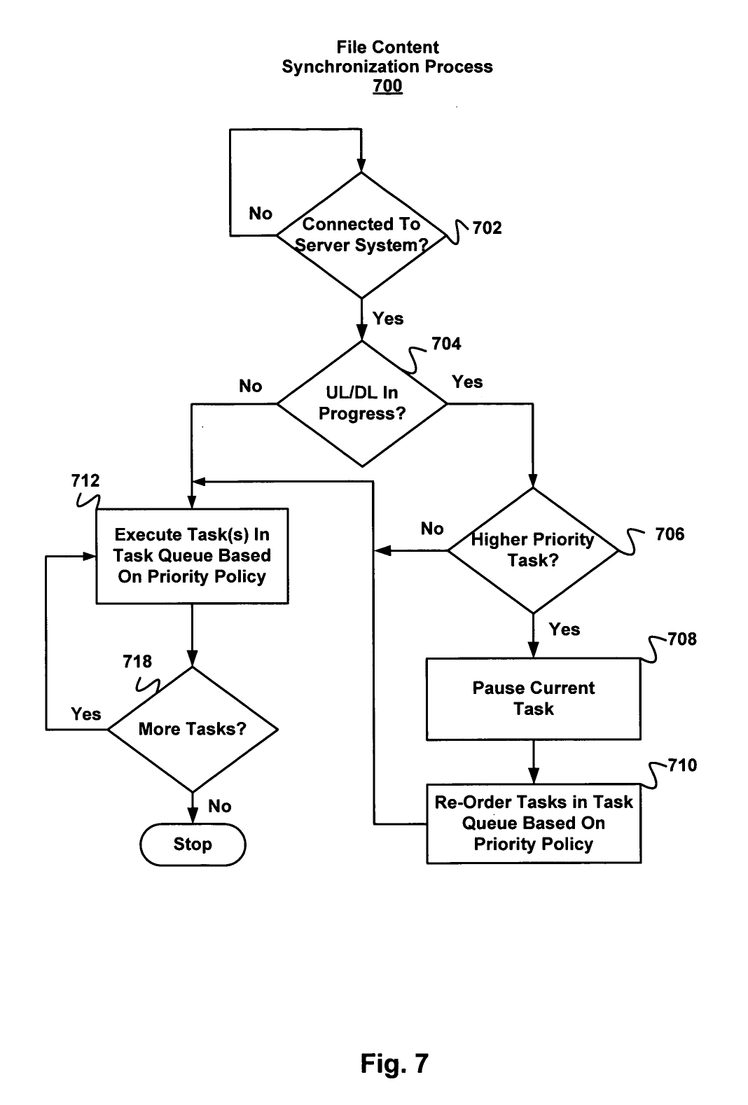

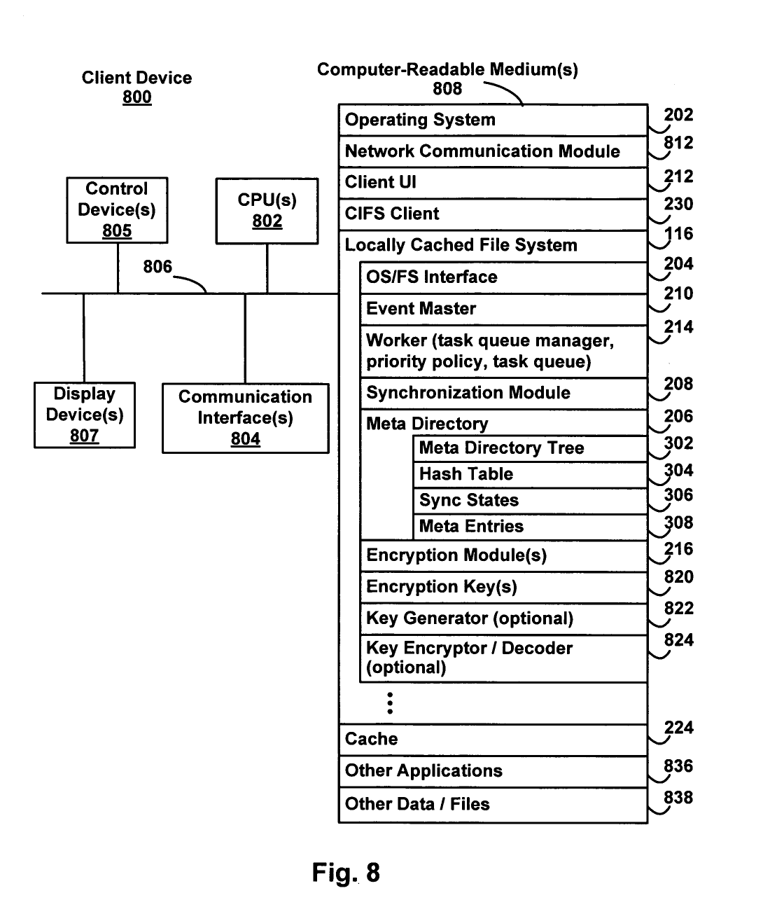

Tasks 410 are received from the event master 210 and stored in the task queue 404. For example, when files need to be uploaded to the server system 104 or downloaded from the server system 104 a corresponding task is added to the task queue 404. The tasks 410 in the task queue 404 are ordered according to the priority policy 408. In some embodiments, the priority policy 408 can be modified or specified by the user via the client UI 212. In some embodiments, each task 410 includes a progress state and a run method that gets called repeatedly until the task 410 completes. The task manager 406 repeatedly gets an unfinished task 410 from the task queue 404 and calls its run method. It then sleeps for a specified delay, allowing for bandwidth throttling. In other embodiments, other mechanisms may be used for bandwidth throttling. If the task 410 fails before it completes, it may be marked as failed and kept on the task queue 404 so that it can be run again at a future time in accordance with the priority policy 408 then in effect. Some examples of a file synchronization process flow 700 and a background process flow 800 performed by the synchronization module 208 are described with respect to FIGS. 7 and 8, respectively. An example of a priority policy is set forth in Table II below. It should be apparent that the priority policy can include more or fewer levels of priority, and the priorities can be determined based on a particular design or user preference.

TABLE II
Example Priority Policy For Synchronization

| Priority Level | Description |
|---|---|
| 1 | Any files that the OS is currently trying to |
| | open that have not yet been downloaded. |
| 2 | Any files that need to be uploaded to the |
| | system server, from least to most recently |
| | modified. |
| 3 | Any files that need to be downloaded that are |
| | in the same folder as the most recently |
| | opened file. |
| 4 | Any files that need to be downloaded that are |
| | in the most recently browsed folder. |
| 5 | Any files that need to be downloaded that are |
| | in subfolders of the most recently browsed |
| | folder. |
| 6 | Any files that need to be downloaded that are |
| | in subfolders of the folder containing the |
| | most recently opened file. |
| 7 | Any files that need to be downloaded from |
| | the user's own user store, from highest to |
| | lowest in the file system hierarchy |
| 8 | Any other files that need to be downloaded, |
| | from the highest to lowest in the file system |
| | hierarchy. |

If the synchronization module 208 is in the middle of a task and another task becomes higher priority, then the current task 410 can be paused until it is again the top priority task. In some embodiments, if during synchronization a conflict is discovered by the synchronization module 208, then the synchronization module 208 launches a conflict resolution procedure to resolve the conflict, as described in co-pending U.S. patent application Ser. No. ______, Attorney Docket No. 60963-5033. An example of a conflict that may be discovered by the synchronization module 208 occurs when the client has modified a file that has an older version number than the corresponding file stored on the file server. Another example of a conflict is where the file server 104 has metadata indicating a new name for a file that conflicts with the name of a new file created on the client system 102. When such conflicts are detected, the user is asked (by the synchronization module 208, via the client UI 212) which version of a file is to be kept. Optionally, the user may be given the opportunity to eliminate the conflict by renaming or moving the local file that conflicts with a corresponding server file.

If all the files of a logged-in user are synchronized, or if a “guest” user is logged-in the client system 102 (i.e., not the owner) and the client system 102 is running and connected to the network 106, the synchronization module 208 can use available bandwidth to synchronize the files of other users who use the file management system 100 on the client system 104. Conflicts discovered during this process can be silently ignored.

In some embodiments, the tasks 410 may include partial downloads. Partial downloads of files may be scheduled based on one or more parameters, including but not limited to file type, file size and/or the available bandwidth between the client system 104 and the remote server system 102.

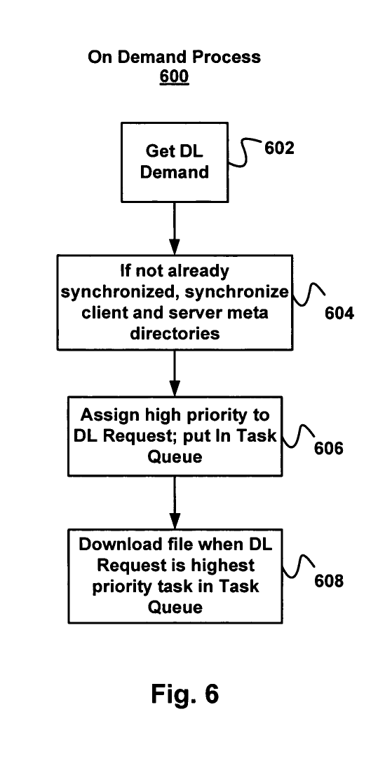

In some embodiments, the priority policy 408 includes prioritizing files or folders of files for transfer based at least in part on a user request to access a file accessible on the server system 104. In some embodiments, the entire file may be transferred or a portion thereof depending upon the file size, file type and/or available bandwidth between the client and server systems 102, 104. In some embodiments, the files can be transferred as a collection of related files (e.g., MP3 files). In some embodiments, the user can change the priority policy via the client UI 212, and can demand that certain files be uploaded or downloaded, as described with respect to FIG. 6. Still in other embodiments, the user is presented (via the client UI 212) with an ordered list of files to be transferred (e.g., in the same order as the tasks in the task queue 404) and is allowed to change the order of file transfers. For example, the list of files to be transferred can be presented to the user if a file transfer requested by the user is predicted (e.g., based on the file size and the available bandwidth) to exceed a threshold transfer time. When the user indicates a ordering change for the ordered list of files, the task queue 404 is automatically updated (e.g., by reordering the tasks 410) to reflect the changes.

### Data Storage Interface

Data storage interface 218 communicates with the OS/FS interface 204, the worker module 214 and the driver 220. In some embodiments, the data storage interface 218 is a software component that organizes files into at least three file layers: a base layer, a change layer and a download layer. The change layer is used to efficiently handle file updates by storing only those portions of the files that have been changed. The download layer is used to receive initial bytes of meta-data downloaded from the server system 104, as described with respect to FIG. 6. For example, a user may request an MP3 file which includes an ID3 tag containing information about the content of the MP3 file (e.g., artist, song title, etc.). The download layer can be used to store the ID3 tag. The base layer is used to store entire files.

In some embodiments, the data storage interface 218 is configured to store groups or sets of small files in respective, larger files, and to provide data storage and retrieval services for those small files. As a result, client device users and the host operating system need not be aware of the fact that groups of small files are stored together in larger files.

### Encryption Module(s)

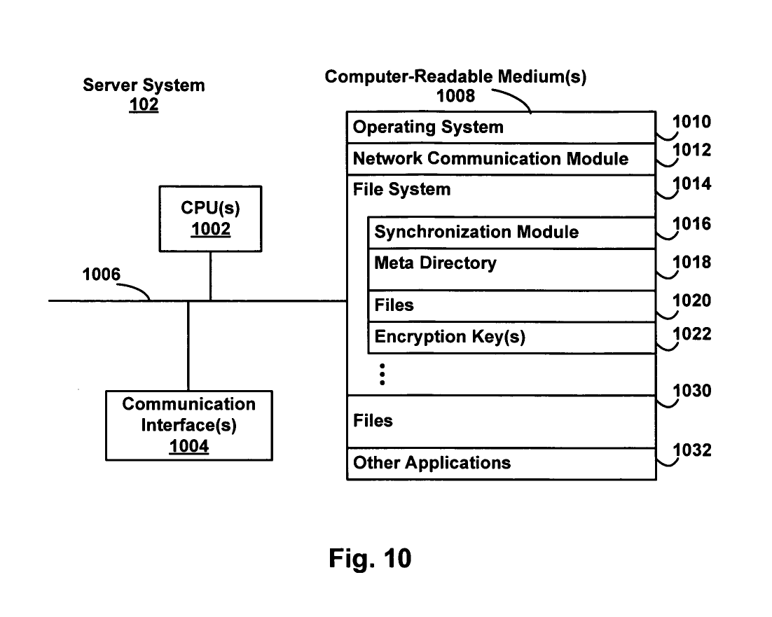

The file system 116 can optionally include one or more encryption modules 216 for encrypting files stored in the locally cached file system 116. The one or more encryption modules 216 allow users to store private data in cache 224 that cannot be read by unauthorized individuals or entities (including people who have access to the server or remote file system). In some embodiments, the one or more encryption modules 216 use symmetric key encryption to encrypt and decrypt files. Furthermore, in some embodiments, the keys used to encrypt and decrypt files are stored in encrypted form on the server system 102 (see 1022, FIG. 10). In these embodiments, the locally cached file system 116 in the client devices may include a key encryption module 824 (FIG. 8) for encrypting and decrypting a key in accordance with a user provided password or pass phrase. The encrypted keys can be distributed by the server system to additional client systems, but can only be decrypted by authorized users (e.g., users who know the password or pass phrase required to decrypt the encrypted keys) of client systems 102. In some embodiments, secure data (i.e., files designated for storage in encrypted form) is always stored in encrypted form on both the locally cached file system 116 and the remote file system 112, and can only be decrypted in memory (e.g., RAM) on the client system 102. The secure data is never cached in plaintext nor transmitted in plaintext over the network 106. However, in some other embodiments, secure data is locally stored in plaintext in the client system, but is never transmitted in plaintext over the network 106 and is never stored in plaintext at the file server.

In some embodiments, asymmetric public-private key encryption is used. The user's private key is generated on the client system 102 and encrypted using a pass phrase and hash function, or any other suitable encryption scheme, before it is sent to the server system 104. The encrypted key is sent to the server system 104 for safe storage, and for distribution to other client devices utilized by the same user. Files or shares that are secure are indicated as such by setting a flag (e.g., IS_ENCRYPTED) in the corresponding meta-entry 308.

In embodiments that use encryption to protect data transmissions between the client and server, an encryption module 216-C is used to encrypt data transmissions to the server and to decrypt data transmissions from the server, thereby providing secure transmissions between the client system 104 and the server system 102. In some embodiments, the server system 102 decrypts the data sent to it by the client system 104, thereby enabling the server to index the documents in the client's locally cached file system, and to provide fast search services to the client using the resulting index. In other embodiments, encrypted files are not decrypted by the server system 102 and are not indexed.

In some embodiments, files in the locally cached file system are locally stored in encrypted form so as to protect the locally stored documents from misuse by unauthorized users of the client system 104. In such embodiments, encryption module 216-A or 216-B may be used to encrypt some or all of the files in the locally cached file system. For instance, the client system 104 may be configured to encrypt all files in folders that are designated as encrypted. Alternately, the client system 104 may be configured to encrypt all locally stored files in the cache 224 of the locally cached file system 116. In yet other embodiments, the client system may be configured to encrypt individually designated files that are stored in the cache 224 of the locally cached file system 116. In these embodiments, when an encrypted file is received from the cache 224 by an authorized user of the client system 104 (e.g., a particular user who has provided a particular password), encryption module 216-A or 216-B automatically decrypts the file as it is retrieved from the cache 224, and provides the decrypted (i.e., clear text) file to the client system for use by the authorized user.

In some embodiments, some or all of the files in the locally cached file system are encrypted when they are uploaded to the server system 104 so that the server system 104 does not have access to the content of the encrypted files. In some of these embodiments, the files to be encrypted are encrypted by encryption module 216-A, 216-B or 216-C while they are being uploaded to the server system 102. As discussed above, the files to be encrypted for storage on the server system may be encrypted using either symmetric key encryption or public-private key encryption. The locally stored copies (sometimes called locally stored versions) of the same files, as stored in the local cache 224, may be stored unencrypted (i.e., in clear text). Alternately, the locally stored copies may be stored in encrypted form, using either the same encryption key and method, or using a different encryption key and/or method as the one used to encrypt the files for storage in the server system. It may be noted that when files are stored in encrypted form on the server system 102, those files cannot be indexed and therefore the server system cannot provide search services (e.g., indexing and search services) for the encrypted files. In some embodiments, the files to be encrypted on the server system are designed on a folder by folder basis. For example, one or more folders of files may be designated as server system encrypted folders, in which case all files in those folders are encrypted when they are uploaded to the server system.

In some embodiments, the meta entries in the meta directory 206 include one or more fields for designating whether the corresponding files or folders are to be stored in encrypted or clear text form on the server system, and for designating whether the corresponding files or folders are to be stored in encrypted or clear text form in the local cache 224. For example, one field of each such meta entry may indicate whether the corresponding file or folder is to be stored in the server system in encrypted or clear text form, and another field of each such meta entry may indicate whether the corresponding file or folder is to be stored in the local cache 24 in encrypted or clear text form.

It is noted that while FIG. 2 shows three potential locations for encryption modules 216-A, 216-B, 216-C, in some embodiments the locally cached file system 116 includes only a single one of these encryption modules 216. For instance, module 216-C is positioned for secure communications with the server system 102, but is not positioned for encrypting locally stored versions of files, while module 216-A is positioned for encrypting and decrypting locally stored versions of files. In other embodiments, the locally cached file system 116 includes two or more of the encryption modules 216. The encryption module instances included in a respective embodiment depend on the encryption services to be provided by the locally cached file system.

### File System Operations

Having described the architecture of the locally cached file system 116, some basic file system operations will now be described to further clarify the operation of the disclosed embodiments.

### Rename Operation

In some embodiments, the user can avoid a conflict between a client file and a server file by renaming the client file, thereby allowing the client file and server file to co-exist. To rename a file the user selects a rename option via the client UI 212, which can be selected, for example, from a pull-down menu presented by the client UI 212. The O/S 202 receives a request to rename the file from the client UI 212 and sends it to the OS/FS interface 204. The OS/FS 204 changes the file name field in the meta-entry 308 associated with the file. In some other embodiments, file renaming is handled by a client application, such an OS shell program.

### Read Operation

To read a file the user selects a “file open” option via the application (e.g., a word processor) being used by the user to read the file. The O/S 202 receives the request and forwards it to the event master 210 and OS/FS interface 204. The OS/FS 204 looks-up the file in the meta-directory 206. If the file is stored in the local cache 224, the file is retrieved from the local cache 224 using, for example, the file ID stored in the file ID field of the meta-entry 308 for the file. If the file is not in the local cache 224, then the event master 210 sends a download task to the worker module 214. The worker module 214 stores the download task in the task queue 404 in accordance with the priority policy 408. The synchronization module 208 can then download the file from the remote file system 112 on the server system 104 when, for example, the task reaches the top of the task queue 404. As noted above, in some embodiments, the task associated with a failed file open request is automatically given highest priority because the user is waiting for the file, and thus this task will be put at the top of the task queue 404.

### Write Operation

To write a file a user selects a save file option in the application (e.g., a word processing application) being used by the user to create, modify or copy the file. The O/S 202 receives the request and forwards it to the OS/FS interface 204. The OS/FS interface 204 looks-up the file in the meta-directory 206, to determine if the file already exists. The OS/FS interface 204 then writes the file to the local cache 224, and creates or updates a corresponding entry in the meta directory 206. If the file previously existed, and already has a file ID assigned to it, the meta-entry 308 for the file will retain the previously assigned file ID, which is stored in the file ID field of the meta-entry 308 for the file. The OS/FS interface 204 sets the IS_DIRTY flag in the meta-entry 308 to indicate that the file contains new or updated content. During the next synchronization cycle, the synchronization module 208 will process the new or updated meta-entry 308 for the file, and will determine that a corresponding upload task is required for sending the new file content to the file server. The worker module 214 stores the upload task in the task queue 404 in accordance with the priority policy 408. The synchronization module 208 can then upload the file to the remote file system 112 when the task reaches the top of the task queue 404.

### Conflict Management

The disclosed embodiments are capable of operating with one or more client systems 102. This is advantageous because it allows one or more users to read, write and modify files on one or more devices and have the files on all the devices synchronized to the remote file system 112.

In some embodiments, the synchronization module 208 periodically or episodically commits changes made by the client system to the server system 104, and also receives meta-data and file content changes from the server system 102. During this synchronization process, the server system 104 accepts file meta-data and content changes from the client that do not conflict with changes to the same files made by other clients, and the client accepts file meta-data and content changes from the server when those changes do not conflict with changes to the same files by the client. However, when the server system has newer changes that have been made to the same file ID by another client system 102, or has a file with the same filename as a client system file, but having a different file ID, the existence of a conflict is detected and the user of the client system 104 is requested to resolve that conflict by selecting the client or server version of the document, or by removing the conflict by renaming or moving the client file to a different filename or file path.

For example, Client A modifies an existing version 0.0 of File X and commits the modified version to the server system 104 for synchronization. The server system 104 performs the synchronization and uploads File X from Client A, and labels it as version 1.0 of File X. Client B then attempts to commit a modified version 0.0 of File X to the server system 104. However, the server system 104 will not accept the modified version 0.0 of File X from Client B, because it conflicts with the version of File X from Client A. Instead, Client B receives from the server system 104 information that identifies the conflict. Client B then provides the user with options for solving the conflict. For example, the user of Client B could be presented with a dialog box, using client UI 212, which asks the user if she wants to overwrite File X, version 1.0. If the user selects the overwrite option, then Client B's modified version 0.0 will be committed to the server system 104 as version 1.0, and will replace or overwrite Client A's version 1.0, which was previously committed to the server system 104. If the user doesn't select the overwrite option, and instead selects a “discard” option, Client B's local version of File X will be overwritten with version 1.0 of File X.

### Metadata Synchronization Process

FIG. 5 is a flow diagram of an embodiment of a metadata synchronization process 500. The metadata synchronization process may be performed separately for each share, or it may be performed for all shares to which a user has access rights. However, since different shares may be stored on different file servers, the following explanation is directed to synchronizing the metadata for a single share. The metadata synchronization process 500 is repeatedly performed periodically (e.g., once every N seconds, where N is in the range of 1 to 10) or episodically (e.g., in response to the occurrence of any one of a predefined set of trigger conditions). As explained in more detail below, some synchronization operations require more than one iteration of the metadata synchronization process 500 to be completed.

In a first phase (operations 502-506), sometimes called the commit phase, the client system sends to the server all client metadata meta-directory entries that have been modified by the client (502). In some embodiments, client meta-directory entries that have been modified are marked with an IS_DIRTY flag. In some embodiments, the entire content of each changed meta-directory entry is sent to the server, while in other embodiments only changed fields of the entry are sent. The server receives the meta-directory entries from the client, identifies any received entries that conflict with entries in the server's corresponding meta-directory, and rejects the conflicting entries (i.e., the received entries that conflict with corresponding entries in the server's meta-directory) (504). In some embodiments, rejected entries are not processed and thus their changed fields are not applied to the corresponding entries in the server's meta-directory. The remaining client meta-directory entries, which do not conflict with entries in the server's corresponding meta-directory, are used to update the server's meta-directory (504). For example, the updating may be performed in some embodiments by updating changed fields in existing meta-directory entries, assigning file IDs to new meta entries and inserting the new meta-directory entries into the server's metadata table.

The server may assign a version number to each new server meta-directory entry and each updated server meta-directory entry. Alternately, or in addition, it may store a timestamp in the server meta-directory entry to indicate the date and time of the last update made to the server meta-directory entry. The server meta-directory entries modified in response to the client meta-directory entries sent to the server are sent to the client (504). Optionally, the server may also send to the client information indicating which client meta-directory entries were rejected because they conflict with entries in the server's meta-directory.

The client processes the received server meta-directory entries (506, 508). One aspect of this processing is identifying meta-directory entries that indicate revised file content located at the client, and scheduling content uploads of those files to the server (506). In some embodiments, the meta-directory entries include a content checksum field, and an update flag for that field that indicates whether the content checksum field contains an updated value. When the upload for a file is completed, the server changes its meta entry to clear the update flag, and that update is copied to the corresponding client meta-directory entry during a next iteration of the metadata synchronization process. Another aspect of processing the received server meta-directory entries is updating or overwriting the corresponding client meta-directory entries with the information in the received server meta entries (508). For example, the received server meta entries may have new version numbers that need to be copied into the corresponding client meta entries. In summary, operations 502 through 508 synchronize updated client meta-directory entries with the corresponding server meta-directory entries, excluding client meta-directory entries that have updates that conflict with server meta-directory entries.

Next, in a second phase of the metadata synchronization process, sometimes called the get updates phase, the client requests from the server copies of all server meta-directory entries revised since the last metadata synchronization (510). As noted above, each meta-directory entry includes a timestamp (synch_ts) indicating the last time the entry was changed on the server. The server identifies and sends to the client the requested server meta-directory entries (512). For ease of explanation, separate discussions are provided for the handling of server meta-directory entries that do not conflict with client meta-directory entries and for the handling of those server meta-directory entries that do conflict with client meta-directory entries. It may be noted that the server meta-directory entries sent to the client at 512 include server meta-directory entries corresponding to any client meta-directory entries rejected by the server at 504 due to conflicting updates.

When a received server meta-directory entry does not conflict with any corresponding client meta-directory entries (i.e., entries having the same file ID and/or the same filename), the metadata changes in the server meta-directory entry are applied to the corresponding client meta-directory entry (514). Alternately, the received server meta-directory entry is used to overwrite the corresponding client meta-directory entry, if any. When there is no corresponding client meta-directory entry, a new client meta-directory entry is generated. In addition, if the server meta-directory entry indicates revised file content located at the server, the client schedules a content download of the files from the server (514).

When a received server meta-directory entry conflicts with one or more corresponding client meta-directory entries (i.e., entries having the same file ID and/or the same filename), the process requires a user to resolve the conflict (516). As noted above, the user may resolve the conflict by selecting a client or server version of a file (and its metadata) as the “winner,” in which case the losing file and/or its metadata will be overwritten by the winning file and/or its metadata, or the user may rename or move the conflicting client file so as to eliminate the conflict. Changes are applied to the client meta-directory in accordance with the user specified resolution of the conflict (516). This may include deleting or revising one or more client meta-directory entries. In addition, the client schedules any file content uploads or downloads needed to implement the user specified resolution of the conflict (516). For instance, when the server meta-directory entry is selected by the user as the winning entry, and that entry includes an update flag or other data that indicates that the content of the corresponding server file is new or updated, a file download is scheduled. More generally, if the server meta-directory entry survives the conflict resolution process and includes an update flag or other data that indicates that the content of the corresponding server file is new or updated, a file download is scheduled. On the other hand, if the conflict resolution process results in a client meta-directory entry that includes an update flag or other data that indicates that the content of the corresponding client file is new or updated, a file upload will be scheduled during the next metadata synchronization cycle (i.e., when operations 502-506 are next performed).

If a new or updated client meta-directory entry includes a file path that requires changes to the directory structure of the meta-directory, then appropriate directory entries (sometimes called folder entries) are created, revised or deleted to reflect the revised directory structure. Similarly, if a file is moved from one directory or folder to another, those changes are reflected in the corresponding meta-directory entries, and all such changes in the client meta-directory are replicated in the server meta-directory during the next metadata synchronization cycle.

### On-Demand Process Flow

FIG. 6 is a flow diagram of one embodiment of an on-demand process 600. In some embodiments, files can be downloaded from the server system 102 in response to user demand. The process 600 begins with the receipt of a download (DL) demand from the user (602). The download demand may occur, for example, when the user attempts to open a file identified by a client meta-directory entry, but the file is not resident in the file cache 119. In some embodiments, a download demand may also be made using the client UI 212. Optionally, if the client meta-directory is not synchronized with the server meta-directory for the share in which the requested file is located, then the metadata synchronization process is executed (604) to ensure that the client meta-directory entry for the requested file is up to date. The download request is assigned a high priority, such as the highest possible priority in the set of priorities that can be assigned to tasks in the task queue 404 (FIG. 4) of the worker module 214 (FIG. 2), and is added to the task queue (606). The requested file is downloaded from the server when the corresponding download request become the highest priority task in the task queue (608). In some embodiments, any lower priority task(s) that are executing at the time the download request is added to the task queue are temporarily suspended while the high priority download request is serviced.

### File Synchronization Process Flow

FIG. 7 is a conceptual flow diagram of one embodiment of a file synchronization process 700. In actual implementation, task execution and queue reordering may be executed as continuous background processes. The file synchronization process 700 determines if the client system 102 is connected to the server system 104 (702), and continues only when a connection is present. If an upload/download task is not in progress (704-No), then the tasks waiting in the task queue 404 of worker module 214 are executed in accordance with the priority policy 408 (712). If a task is in progress (704-Yes), but the task at the top of the task queue 404 has higher priority (706-Yes), then the task in progress is paused (708). Optionally, the task queue 404 is re-ordered (710) in accordance with the priorities assigned to the tasks in the task queue and/or in accordance with a priority policy. The task at the top of the task queue is executed (712). If there are more tasks to execute (718-Yes), then those tasks are executed in accordance with the priority policy or order in the task queue 404.

While the processes 500, 600 and 700 described above include a number of operations that appear to occur in a specific order, it should be apparent that these processes can include more or fewer operations, some of which can be executed serially or in parallel (e.g., using parallel processors or a multi-threading environment).

### Computer Embodiment

FIG. 8 is a block diagram of one embodiment of a client device 800 for implementing a locally cached file system 116. The client device 800 includes one or more buses 806 coupled to one or more processors 802, a communications interface 804, optional control device(s) 805, optional display device(s) 807 and one or more computer-readable mediums 808. The computer-readable medium(s) 808 can be any device or medium that can store executable programs or instructions and/or data for use by the one or more processors 802. The medium(s) 808 can include a memory hierarchy, including but not limited to, cache, main memory and secondary memory. The memory hierarchy can be implemented using any combination of RAM (e.g., SRAM, DRAM, DDRAM), ROM, FLASH, magnetic and/or optical storage devices. The computer-readable medium 808 may further include remotely located storage coupled to the client device 800 by a communications network, including but not limited to one or more of the Internet, intranet(s), Local Area Networks (LANs), Wide Local Area Networks (WLANs), Storage Area Networks (SANs) and the like.

The optional control devices 805 (e.g., a mouse and keyboard, or keypad, touch sensitive display, etc.) and the display devices 807 (e.g., CRT, LCD, etc.) enable a user to communicate and control various aspects of the client device 800. The communications interface 804 can be a port, network interface card, wireless interface card or the like. In some embodiments, the communications interface is a USB or FIREWIRE port for connecting with the server system 104 via a network 106 (e.g., the Internet).

The computer-readable medium 808 includes an operating system 202 (e.g., WINDOWS, LINUX, MAC OS, UNIX, etc.) having various software components and drivers for controlling and managing various tasks (e.g., memory management, hard disc control, power management, etc.). A network communication module 812 includes software programs and/or protocol stacks for establishing and maintaining communication links with other devices or networks via the communications interface 804. A client user interface (UI) module 212 is used in conjunction with a physical user interface, including display devices 807 and control devices 805, to exchange information with a user. CIFS client 230 is described above.

Computer-readable medium 808 also includes a locally cached file system 116, and a cache 224 for storing locally cached files. In some embodiments, the cache 224 is physically located, at least in part, in non-volatile memory devices. The locally cached file system 116 includes the following components or modules, or a subset thereof: a client UI 814, an OS/FS interface 204, an event master 210, a worker module 214, a synchronization module 208, a meta-directory 206, and a data storage interface 218. In embodiments that provide file and/or folder encryption, the locally cached file system 116 also provides one or more encryption modules 216, and encryption keys 820. In some embodiments, the locally cached file system 116 further provides a key generator module 822 for generating one or more encryption keys 820, and optionally includes a key encryption module 824 for encrypting one or more of the encryption keys 820. For instance, the key encryption module 824 may encrypt and decrypt an encryption key using (i.e., in accordance with) a password or pass phrase that is provided by a user, but which is not stored by either the client device or server system. Computer-readable medium 808 of client device 808 may also include one or more applications 836 (e.g., browser, word processor, etc.) as well as additional files or data 838. The meta-directory 206 includes a meta-directory tree 302, a hash table 304, sync states 306, and meta entries 308, as discussed above with reference to FIG. 3. These components include code or instructions for performing various file management tasks, as described with respect to FIGS. 1-7. In some embodiments, at least some of these components can be at least partially implemented in hardware.

Each of the above identified modules and applications in client device 800 corresponds to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, computer-readable medium 808 may store a subset of the modules and data structures identified above. Furthermore, computer-readable medium 808 may store additional modules and data structures not described above.

In some embodiments, server system 102, as shown in FIG. 10, includes one or more processors (CPUs) 1002, one or more communication interfaces 1004, memory (one or more computer-readable mediums) 1008, and one or more communication busses 1006 for interconnecting the various components of the server system 102. In some embodiments, memory 1008 includes the following modules, sets of instructions, and data structures, or a subset or superset thereof: an operating system 1010, a network communications module 1012, a file system 1014, files 1030 (e.g., files that are synchronized between the server system 102 and one or more client devices), and other applications 1032. In some embodiments, the file system 1014 includes a synchronization module 1016 (which performs the server portion of the synchronization processes described above), a meta directory 1018, and files 1020. The file system 1014 may optionally store encryption keys 1022 used by the client devices. As described above, the encryption keys 1022 stored at the server may be encrypted so as to make the encryption keys unusable by the server system 102 and to thereby protect the privacy of the client files stored in the file system 1014.

Each of the above identified modules and applications in server system 102 corresponds to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 1008 may store a subset of the modules and data structures identified above. Furthermore, memory 1008 may store additional modules and data structures not described above.

The disclosed embodiments are not intended to be exhaustive or limited to the precise forms disclosed. Many modifications and variations to the disclosed embodiments are possible in view of the above teachings.

1. A non-transitory computer-readable medium having stored thereon instructions, which, when executed by one or more processors in a first computer system adapted for connection to a computer network, causes the one or more processors to perform the operations of:
accessing a first file system in memory coupled to the one or more processors, wherein the first file system is associated with a second file system located on the computer network;
enabling user interaction with the first file system; and
automatically synchronizing at least portions of the first file system with the second file system asynchronously, wherein the synchronizing includes:
generating a list of files to be synchronized, the list of files including a plurality of files;
ordering the plurality of files for synchronization in accordance with a priority policy, wherein the priority policy includes ordering the plurality of files in accordance with a user request to access a file in the plurality of files, and in accordance with at least one of: file size, file location, and file modification times; and
transferring files and file updates for the ordered plurality of files between the first and second file systems, wherein the files being transferred and updated have associated meta-data and file content.

2. (canceled)

3. The computer-readable medium of claim 1, wherein the user request to access the file comprises a user request to access a file accessible on the second file system, but not accessible on the first file system.

4. The computer-readable medium of claim 1, wherein the priority policy further includes ordering the plurality of files in accordance with file access times.

5. The computer-readable medium of claim 1, wherein the synchronizing comprises automatically synchronizing the at least portions of the first file system with the second file system in response to a user request to access a file accessible on the second file system.

6. The computer-readable medium of claim 1,
wherein the synchronizing includes a first operation and a second operation, the first operation including synchronizing the meta-data of the files being transferred and updated, and the second operation including synchronizing the file content of the files being transferred and updated, wherein the first operation is performed without regard to the priority policy.

7. The computer-readable medium of claim 6, wherein the first operation is performed prior to the second operation.

8. The computer-readable medium of claim 1, wherein the synchronization further includes, prior to ordering the plurality of files for synchronization, pausing synchronization of a first file; and
wherein ordering the plurality of files for synchronization in accordance with the priority policy includes re-ordering the first file.

9. (canceled)

10. The computer-readable medium of claim 1, wherein the priority policy includes synchronization of a predefined portion of a file before transferring the full file.

11. The computer-readable medium of claim 1, further comprising instructions for enabling a user to change the priority policy.

12. The computer-readable medium of claim 1, further comprising instructions for presenting a user with the ordered plurality of files, and instructions for enabling the user to modify the ordered plurality of files.

13. The computer-readable medium of claim 12, wherein the ordered plurality of files is presented to the user if a file transfer requested by the user exceeds a threshold transfer time.

14. The computer-readable medium of claim 1, wherein the list of files to be synchronized includes one or more files from a first share and one or more files from a second share, distinct from the first share.

15. A method of managing files over a network, comprising:
at a client device having one or more processors and memory storing one or more programs to be executed by the one or more processors so as to perform the method:
accessing a first file system in the client device, wherein the first file system is associated with a second file system located on the computer network;
enabling user interaction with the first file system; and
automatically synchronizing at least portions of the first file system with the second file system asynchronously wherein the synchronizing includes:
generating a list of files to be synchronized, the list of files including a plurality of files;
ordering the plurality of files for synchronization in accordance with a priority policy, wherein the priority policy includes ordering the plurality of files in accordance with a user request to access a file in the plurality of files, and in accordance with at least one of: file size, file location, and file modification times; and
transferring files and file updates for the ordered plurality of files between the second file system and the first file system, wherein the files being transferred and updated have associated meta-data and file content.

16. (canceled)

17. The method of claim 15, wherein the user request to access the file comprises a user request to access a file accessible on the second file system, but not accessible on the first file system.

18. The method of claim 15, wherein the priority policy further includes ordering the plurality of files in accordance with file access times.

19. The method of claim 15, wherein the synchronizing comprises automatically synchronizing the at least portions of the first file system with the second file system in response to a user request to access a file accessible on the second file system.

20. The method of claim 15,
wherein the synchronizing includes a first operation and a second operation, the first operation including synchronizing the meta-data of the files being transferred and updated, and the second operation including synchronizing the file content of the files being transferred and updated, wherein the first operation is performed without regard to the priority policy.

21. The method of claim 20, wherein wherein the first operation is performed prior to the second operation.

22. The method of claim 15, wherein the synchronization further includes, prior to ordering the plurality of files for synchronization, pausing synchronization of a first file; and
wherein ordering the plurality of files for synchronization in accordance with the priority policy includes re-ordering the first file.

23. The method of claim 15, wherein the priority policy includes synchronization of a predefined portion of a file before transferring the full file.

24. The method of claim 15, further comprising enabling a user to change the priority policy.

25. The method of claim 15, further comprising presenting a user with the ordered plurality of files, and enabling the user to modify the ordered plurality of files.

26. The method of claim 25, wherein the ordered plurality of files is presented to the user if a file transfer requested by the user exceeds a threshold transfer time.

27. A computer, comprising:
one or more processors;
memory, including a first file system stored in the memory, and instructions stored in the memory and executable by the one or more processors; the instructions including:
instructions for accessing the first file system, wherein the first file system is associated with a remotely located second file system located on a computer network;
instructions for enabling user interaction with the first file system; and
instructions for automatically synchronizing at least portions of the first file system with the second file system asynchronously wherein the synchronizing includes:
generating a list of files to be synchronized, the list of files including a plurality of files;
ordering the plurality of files for synchronization in accordance with a priority policy, wherein the priority policy includes ordering the plurality of files in accordance with a user request to access a file in the plurality of files, and in accordance with at least one of: file size, file location, and file modification times; and
transferring files and file updates for the ordered plurality of files between the second file system and the first file system, wherein the files being transferred and updated have associated meta-data and file content.

28. (canceled)

29. The computer of claim 27,
wherein the synchronizing includes a first operation and a second operation, the first operation including synchronizing the meta-data of the files being transferred and updated, and the second operation including synchronizing the file content of the files being transferred and updated, wherein the first operation is performed without regard to the priority policy.

30. The computer of claim 27, wherein the synchronization further includes, prior to ordering the plurality of files for synchronization, pausing synchronization of a first file; and
wherein ordering the plurality of files for synchronization in accordance with the priority policy includes re-ordering the first file.

31. (canceled)

32. The method of claim 15, wherein the list of files to be synchronized includes one or more files from a first share and one or more files from a second share, distinct from the first share.

33. The computer of claim 27, wherein the user request to access the file comprises a user request to access a file accessible on the second file system, but not accessible on the first file system.
